(19) United States
(12) Patent Application Publication
(10) Pub. No.: US 2016/0229265 A1
(43) Pub. Date: Aug. 11, 2016

(54) VEHICLE SPEED INDUCED VENTILATION FOR MOTOR VEHICLE

(71) Applicant: FORD GLOBAL TECHNOLOGIES, LLC, Dearborn, MI (US)

(72) Inventor: Robert Steven Sawyer, Oakland, MI (US)

(21) Appl. No.: 14/617,218

(22) Filed: Feb. 9, 2015

(51) Int. Cl. B60H 1/26; B60H 3/06

(52) U.S. Cl. CPC B60H 1/26; B60H 3/0641

(57) ABSTRACT

A supplemental air distribution system for a motor vehicle includes comprising one or more supplemental ducts for directing ambient air from an exterior of the motor vehicle to a passenger cabin interior. The one or more supplemental ducts each include an actuable door for allowing and preventing airflow. Cooling air is supplied from the one or more supplemental ducts to the passenger cabin interior via dash panel ducts and one or more register outlets. Advantageously, the one or more supplemental ducts bypass at least the vehicle heating, ventilation, and air-conditioning (HVAC) evaporator and blower assembly of the vehicle, preventing absorption of heat and moisture therefrom by the ambient air prior to entering the passenger cabin interior. Methods and HVAC systems for distributing ambient air to a motor vehicle passenger cabin are described also.

### TECHNICAL FIELD

This disclosure relates generally to motor vehicle ventilation systems. More particularly, the disclosure relates to a motor vehicle ventilation system including a supplemental air distribution system which allows cooling an interior of the vehicle passenger cabin without requiring activation of any element of the vehicle heating, ventilation, and air-conditioning (HVAC) system.

### BACKGROUND

Modern motor vehicle heating, ventilation, and air-conditioning (HVAC) systems are efficient, effective mechanisms for conditioning ambient air provided to a passenger cabin of the motor vehicle, cooling or heating the air dispensed into the passenger cabin as needed. However, because vehicle HVAC systems rely on vehicle engine operation for power, operation of the HVAC system is known to reduce vehicle fuel efficiency by as much as 5-10% compared to the fuel efficiency achievable by the vehicle without the HVAC system activated. In particular, the air-conditioning components of the HVAC system reduce vehicle fuel efficiency, because a variety of HVAC elements including compressors, evaporators, forced-air blowers, etc. are required to cool air before it is dispensed into the vehicle passenger cabin. To avoid this reduction in fuel efficiency, particularly on relatively mild days the temperature of the passenger cabin can be lowered by the simple expedient of rolling one or more of the passenger cabin windows down to increase airflow through the cabin. However, the open window(s) may act as a wind scoop, reducing aerodynamic properties of the vehicle. The increased drag created by rolling down the vehicle windows therefore likewise reduces fuel efficiency.

For that reason, modern motor vehicle HVAC systems can be operated in “vent mode,” that is, configured to provide outside ambient air directly to the vehicle passenger cabin through existing register outlets without actively cooling the air via the air conditioning system compressor and evaporator, etc. Vehicle HVAC systems operating in vent mode typically require operation of at least the HVAC blower to move ambient air into the passenger cabin, and so still impair vehicle fuel efficiency compared to operation of the vehicle without activation of any element of the HVAC system.

Moreover, typically the duct and vent systems of the vehicle require that the outside air pass through the entire HVAC system and air distribution system before the air passes through the register outlets leading into the passenger cabin. The typical vehicle HVAC/air distribution system defines a relatively lengthy and tortuous airflow path, which in turn creates a system pressure drop that reduces the airflow volume/velocity exiting the passenger cabin register outlets due to resistance to passage of air from those components. Moreover, during this passage the air absorbs heat, moisture, etc. from various HVAC system components including the evaporator-blower assembly, the heater core, and others. As a result, a time delay is created for the airflow exiting the register outlets to cool, particularly if the ambient air entering the air distribution system is already warm. As a result, at least initially air may exit the passenger cabin register outlets at a higher temperature and/or humidity than the actual ambient air, contributing to passenger discomfort.

Still more, many modern motor vehicles are designed including systems that improve fuel efficiency by reducing operation. For example, certain vehicles may be equipped with stop-start enabled powertrains, hybrid fuel-electric powertrains, fully electric powertrains and the like. In such systems, engine operation is less consistently available to power the vehicle HVAC systems.

To solve these and other problems, the present disclosure relates to a supplemental air distribution system for providing cooling air to an interior of a motor vehicle passenger cabin without activating any element of the vehicle HVAC system. Advantageously, the supplemental air distribution system allows intake of ambient air directly from an exterior of the vehicle and distribution thereof into the vehicle passenger cabin via a portion of the vehicle's existing air distribution system, relying only on the vehicle forward motion to impel the air into the vehicle rather than operation of a blower or other fan arrangement as is the case with conventional vehicle venting systems. Moreover, the supplemental air distribution system directs the ambient air to the vehicle passenger cabin register outlets via the shortest, most direct route possible, bypassing certain components of the vehicle HVAC system that would otherwise undesirably impart heat and/or moisture to the air. Thus, passenger comfort is improved without sacrificing fuel efficiency during operation of the vehicle.

### SUMMARY

In accordance with the purposes and benefits described herein, in one aspect a supplemental air distribution system for a motor vehicle is described, comprising one or more ducts for directing ambient air from an exterior of the motor vehicle to a passenger cabin interior. Advantageously, the one or more ducts bypass at least an HVAC evaporator and blower assembly of the vehicle, preventing absorption of heat and moisture from components of the HVAC by ambient air passing through the supplemental air distribution system. The one or more ducts each include an actuable door for allowing and preventing an airflow therethrough. Air pressure created by motion of the motor vehicle in operation drives passage of the air through the supplemental air distribution system, obviating any need for operation of the HVAC blower to move ambient air into the passenger cabin interior.

In an embodiment, the one or more ducts direct ambient air from a motor vehicle ambient air inlet directly to existing components of the vehicle air distribution system, that is, to a vehicle duct system supplying air to the passenger cabin via one or more dash panel register outlets. In alternative embodiments, the one or more ducts direct ambient air from the motor vehicle ambient air inlet, through one or more air inlet air filters, and then directly to the vehicle duct system supplying air to the passenger cabin via the one or more register outlets. In another alternative embodiment, the one or more ducts direct ambient air from the motor vehicle ambient air inlet, through a plenum, and then directly to the vehicle duct system supplying air to the passenger cabin via the one or more register outlets. In yet another alternative embodiment, the one or more ducts direct ambient air from the motor vehicle ambient air inlet, through one or more air inlet air filters, through a plenum, and then directly to the vehicle duct system supplying air to the passenger cabin via the one or more register outlets.

In another aspect, the present disclosure describes a method for distributing cooling air to an interior of a passenger cabin of a motor vehicle, comprising providing a supplemental air distribution system as described above for directing cooling ambient air to the passenger cabin interior. For the advantages described above, the one or more ducts are configured to bypass at least the vehicle HVAC evaporator and blower assembly while transporting ambient air to the vehicle duct system supplying air to the passenger cabin via one or more dash panel register outlets.

In yet another aspect, the present disclosure describes a motor vehicle air distribution system which includes a heating, ventilation, and air-conditioning (HVAC) unit comprising at least a compressor, an evaporator, and a forced-air blower as are known in the art. The described system includes a primary air distribution system including an ambient air inlet, a plenum, one or more dash panel register outlets supplying air to an interior of a passenger compartment of the vehicle, and one or more ducts placing the ambient air inlet in fluid communication with the HVAC unit, the plenum, and the one or more register outlets. In turn, the system includes a supplemental air distribution system as described above, including one or more supplemental ducts which bypass the at least an evaporator and a blower of the HVAC unit but place the ambient air inlet in fluid communication with at least the one or more register outlets. Various embodiments of the supplemental air distribution system are substantially as described above.

In the following description, there are shown and described embodiments of the disclosed motor vehicle supplemental air distribution system. As it should be realized, the structure is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed motor vehicle supplemental air distribution system, and together with the description serve to explain certain principles thereof. In the drawings:

FIG. 1 depicts a motor vehicle HVAC system and air distribution system including a supplemental air distribution system according to the present disclosure;

FIG. 2 depicts an alternative embodiment of the supplemental air distribution system of FIG. 1;

FIG. 3 depicts another alternative embodiment of the supplemental air distribution system of FIG. 1;

FIG. 4 depicts yet another alternative embodiment of the supplemental air distribution system of FIG. 1;

FIG. 5 depicts a motor vehicle console including an actuator for a supplemental air distribution system according to the present disclosure; and

FIG. 6 depicts an actuator for operating an actuable door for a supplemental air distribution system according to the present disclosure.

Reference will now be made in detail to embodiments of the disclosed motor vehicle supplemental air distribution system, examples of which are illustrated in the accompanying drawing figures.

### DETAILED DESCRIPTION

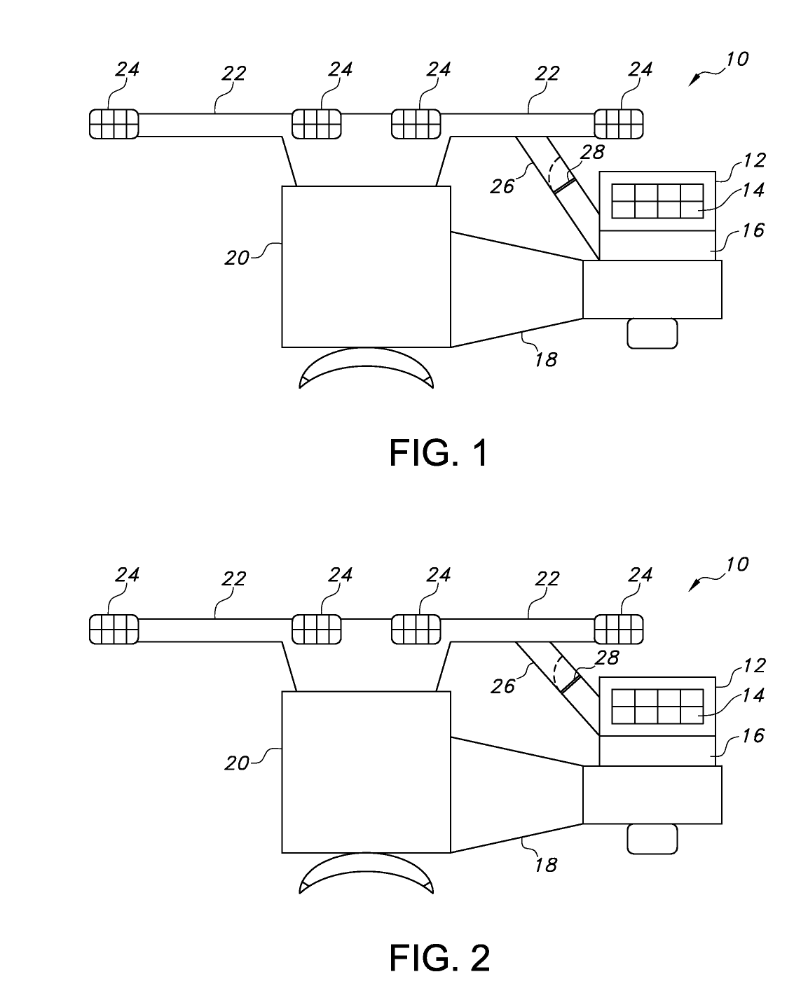

The basic components of a motor vehicle HVAC and air distribution system are well known in the art, and do not require detailed description herein. However, at a high level, with reference to FIG. 1 a motor vehicle HVAC and air distribution system 10 includes at least one ambient air inlet (also referred to as a fresh air inlet) 12 for providing ambient air from an exterior of the vehicle to the vehicle passenger cabin interior. The ambient air inlet 12 typically includes a debris screen 14, and is also typically provided with a cabin air filter 16 for removing smaller particulates from ambient air before dispensing into the passenger cabin.

Typically the temperature and volume of air dispensed into the passenger cabin via the HVAC system are controlled. The volume of air is controlled by a blower. The air temperature is controlled by adjusting a ratio of hot air (generated by the HVAC heating elements) and cold air (generated by the HVAC cooling elements) dispensed into the passenger cabin. A portion of these HVAC heating/cooling elements are depicted generally as HVAC evaporator-blower assembly 18. A plenum 20 is provided, which as is known is an air-distribution device for distributing conditioned air to various vehicle dash panel ducts 22. Conditioned air then passes via the panel ducts 22 to one or more register outlets 24, and therefrom into the vehicle passenger cabin. As is also known, fans (not shown) may be provided to recirculate air from the passenger cabin back through the HVAC components for additional heating or cooling, and then passed back into the passenger cabin.

Placing a vehicle HVAC system in “vent mode,” allows air to be drawn into the ambient air inlet 12 and passed into the vehicle passenger cabin without activating the vehicle HVAC heating and/or cooling elements. However, conventionally in vent mode the HVAC blower is required to move ambient air into the passenger cabin. Thus, even in vent mode ambient air must pass through the HVAC evaporator-blower assembly 18, where undesirable heat and/or moisture may be absorbed. Further, as summarized above the HVAC blower relies on the vehicle engine for power, and so even in vent mode vehicle fuel efficiency is compromised.

To solve these problems, a supplemental air distribution system is provided for cooling an interior of a motor vehicle passenger cabin, including at least one supplemental duct 26 which directs ambient air from the ambient air inlet 12 to the dash panel ducts 22/register outlets 24 by the shortest airflow path possible. Advantageously, at least one supplemental duct 26 entirely bypasses the HVAC evaporator-blower assembly 18, avoiding the conventional vent mode problems of heat/moisture absorption and blower operation as summarized above. Instead, the described supplemental air distribution system relies entirely on vehicle movement to create airflow into the passenger cabin. Thus, the air is kept at a temperature closer to that of the ambient air compared to conventional HVAC vent mode. In turn, a shorter airflow path is provided, reducing the airflow pressure drop experienced with conventional vent modes that direct air through all components of the HVAC and air distribution systems, and operation of the HVAC blower is not required.

In the embodiment depicted in FIG. 1, ambient air is routed from an exterior of the vehicle into ambient inlet 12, through cabin filter 16, and directly therefrom to dash panel ducts 22. However, the skilled artisan will readily recognize that alternative configurations are possible, while still by-passing the HVAC evaporator-blower assembly 18. All such alternative configurations are contemplated for use herein. For example, in one alternative embodiment depicted in FIG. 2, ambient air is routed from an exterior of the vehicle into ambient inlet 12 and directly therefrom to dash panel ducts 22.

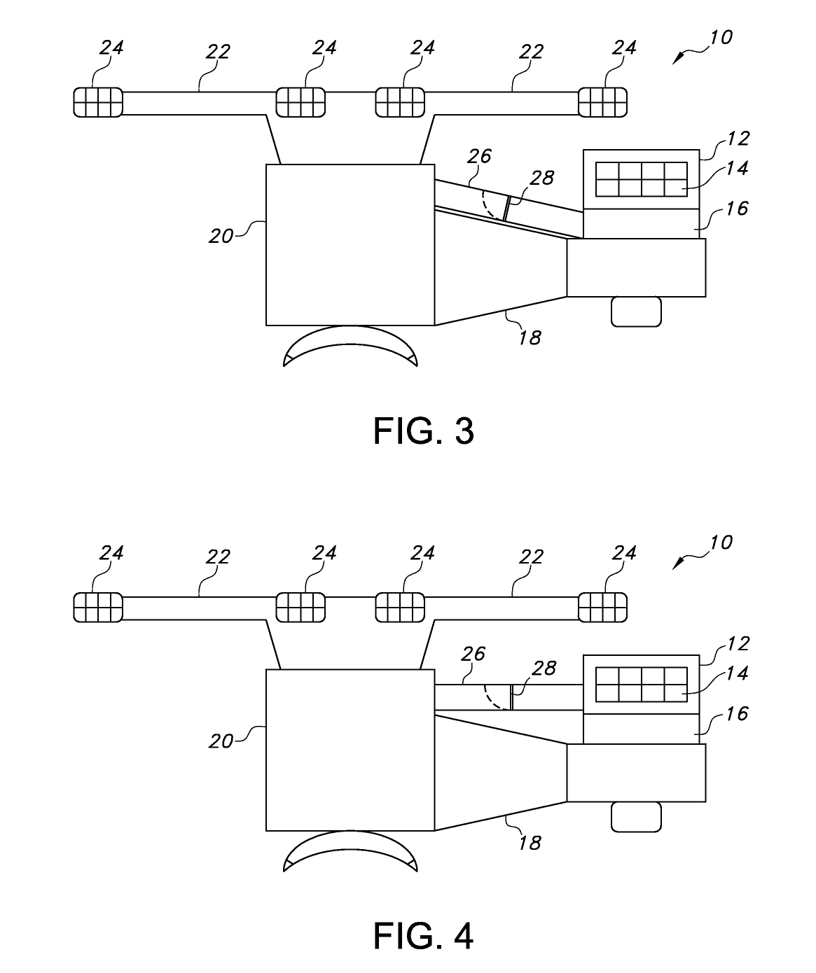

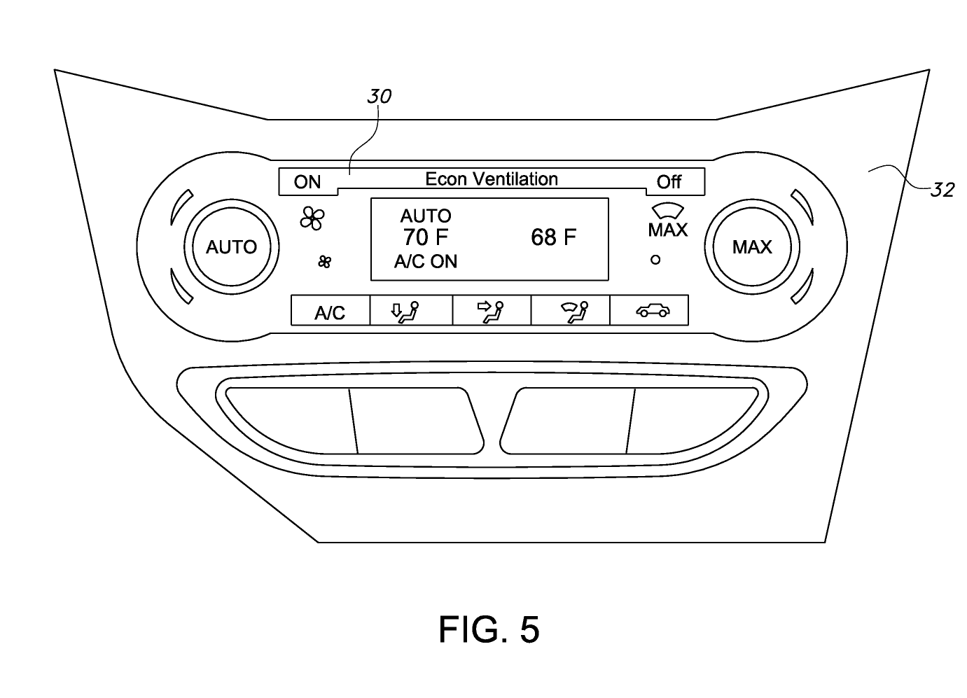

In another possible alternative embodiment depicted in FIG. 3, ambient air is routed from an exterior of the vehicle into ambient inlet 12 through cabin air filter 16 to plenum 20, and is distributed therefrom to dash panel ducts 22.

In still yet another possible alternative embodiment depicted in FIG. 4, ambient air is routed from an exterior of the vehicle into ambient inlet 12 directly to plenum 20, and is distributed therefrom to dash panel ducts 22.

It will be appreciated that in each of the described embodiments, ambient air is routed to dash panel ducts 22 and therefrom through register outlets 24 into the vehicle passenger cabin, reducing a distance the air must travel. The HVAC evaporator-blower assembly 18 is bypassed, and so there is no issue of heat/moisture absorption as summarized above. The temperature and moisture content of the air entering the passenger cabin is much closer to the temperature/moisture content of the ambient air than is the case for a conventional motor vehicle HVAC/air distribution system operating in vent mode.

Because air distribution according to the present disclosure does not rely on activation of the vehicle HVAC blower, it will be appreciated that it is the vehicle's forward momentum that supplies the air pressure necessary to move air through the described system. For that reason, an actuable door 28 is provided in an interior of the at least one supplemental duct 26 to allow or prevent airflow through the supplemental duct 26 as needed. As will be appreciated, operation of the door 28 may be achieved by any number of suitable mechanisms known in the art. In one example, for passenger convenience a switch 30 may be provided in a vehicle HVAC control console 32 or elsewhere, such as in the vehicle dash panel (not shown), in the driver-side or one or more passenger doors (not shown), etc. The console 32 may be disposed at any convenient location, such as between the driver and front passenger seats (not shown), as an overhead console integrated into the vehicle passenger compartment roof and depending into the passenger compartment (not shown), and the like. It will readily be appreciated that the switch 30 may be provided in any suitable configuration, such as a switch, a button, a lever, a slide, etc.

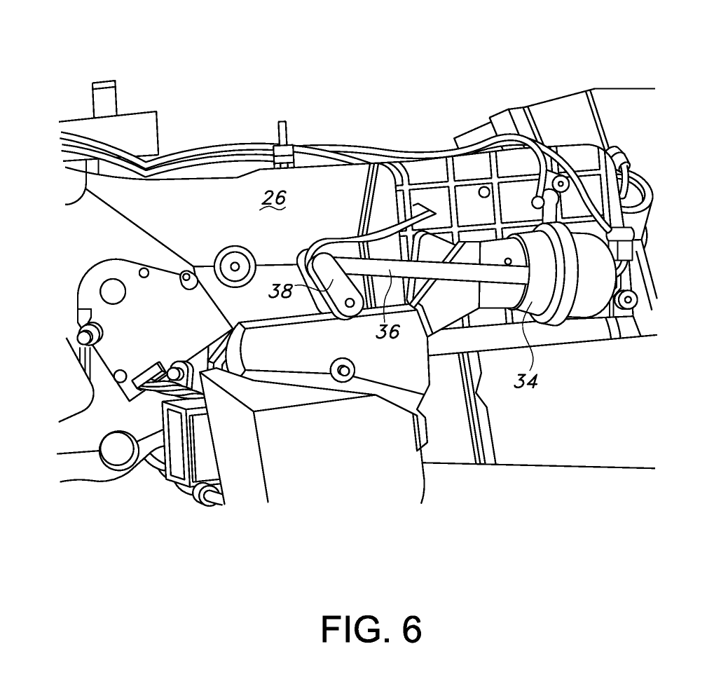

Various mechanisms for actuating an air duct door such as actuable door 28 are known in this art, and all such mechanisms are contemplated for use herein. For example, as depicted in FIG. 6, an actuator 34 may be provided including an arm 36 for actuating a door pivot connection 38 to open and close door 28 (not shown in this view). A variety of suitable mechanisms for operating actuators 34 are known and are contemplated for use herein, including electric servo motors, vacuum-operated actuators 34, hydraulic-operated actuators 34, pneumatic-operated actuators 34, and others.

Still more, “smart” systems are contemplated for controlling the operation of the actuable door 28 to allow (or not allow) airflow through supplemental duct 26. Such systems could include controllers (not shown) including processors, memory, etc. which determine from data provided by various sensors such as external temperature sensors, sensors determining vehicle operating conditions, and others, that activation of the vehicle HVAC system would unduly negatively impact vehicle fuel economy or is not possible. For example, sensors may determine that the vehicle is operating at or above a predetermined minimum required speed for use of the supplemental air distribution system. Other sensors may detect one or more exterior ambient conditions such as temperature, humidity, and the like, and compare those detected conditions to stored values for temperature, humidity, etc. A processor of the controller may compare the detected ambient conditions to pre-determined ambient condition values of temperature, humidity, to pre-determined threshold values for temperature, humidity, and the like that are stored in memory. By this comparison, the controller may make a determination that the ambient conditions are sufficient to cool the passenger compartment to an operator-set temperature, and automatically open actuable door 28 to allow airflow through supplemental duct 26 to cool the passenger cabin, preventing the impairment in fuel efficiency that would result from activating the HVAC system.

As another example, in hybrid fuel-electric vehicles, under certain operating conditions the vehicle engine will automatically be stopped. In vehicles equipped with stop-start enabled powertrains, the vehicle engine may be stopped while the vehicle is operating at certain cruising speeds. In each of these situations, sensors associated with the vehicle engine can send a signal to the controller that the vehicle engine is not operating, and so that the HVAC system which requires engine power to operate should not be activated. In such situations, instead of activating the HVAC system to cool the passenger cabin interior and potentially requiring starting the engine, the controller may instead require defaulting to the present supplemental air distribution system, and automatically open actuable door 28 to allow airflow through supplemental duct 26 to cool the passenger cabin.

Thus, by the above-described structures, a supplemental air distribution system is provided which allows providing ambient air to cool an interior of the vehicle passenger cabin without involving the HVAC system blower, relying instead on vehicle forward momentum to supply air pressure. The supplemental air distribution system, by moving ambient air from an exterior of the vehicle to the passenger cabin interior by the shortest route possible and by-passing the HVAC evaporator-blower assembly, reduces absorption of heat and moisture by the air and so provides air to the passenger cabin that is similar in temperature/moisture to the ambient air. In turn, supplying cool air to the passenger cabin without activating any component of the HVAC system is possible, thus improving vehicle fuel efficiency.

Obvious modifications and variations are possible in light of the above teachings. All such modifications and variations are within the scope of the appended claims when interpreted in accordance with the breadth to which they are fairly, legally and equitably entitled.

What is claimed:

1. A supplemental air distribution system for a motor vehicle, comprising one or more ducts for directing ambient air from an exterior of the motor vehicle to a passenger cabin interior, wherein the one or more ducts bypass at least a vehicle heating, ventilation, and air-conditioning (HVAC) evaporator and blower assembly of the vehicle.

2. The system of claim 1, wherein the one or more ducts each include an actuable door for allowing and preventing an airflow therethrough.

3. The system of claim 2, wherein the one or more ducts direct ambient air from a motor vehicle ambient air inlet directly to a vehicle duct system supplying air to the passenger cabin via one or more register outlets.

4. The system of claim 2, wherein the one or more ducts direct ambient air from the motor vehicle ambient air inlet, through one or more air inlet air filters, and then directly to the vehicle duct system supplying air to the passenger cabin via the one or more register outlets.

5. The system of claim 2, wherein the one or more ducts direct ambient air from the motor vehicle ambient air inlet, through a plenum, and then directly to the vehicle duct system supplying air to the passenger cabin via the one or more register outlets.

6. The system of claim 2, wherein the one or more ducts direct ambient air from the motor vehicle ambient air inlet, through one or more air inlet air filters, through a plenum, and then directly to the vehicle duct system supplying air to the passenger cabin via the one or more register outlets.

7. A motor vehicle including the system of claim 1.

8. A method for distributing cooling air to an interior of a passenger cabin of a motor vehicle, comprising configuring one or more ducts to bypass at least a vehicle heating, ventilation, and air-conditioning (HVAC) evaporator and blower assembly of the vehicle to direct ambient air from an exterior of the motor vehicle to a passenger cabin interior.

9. The method of claim 8, including providing the one or more ducts with an actuable door for allowing and preventing an airflow therethrough.

10. The method of claim 9, including configuring the one or more ducts to direct ambient air from a motor vehicle ambient air inlet directly to a vehicle duct system supplying air to the passenger cabin via one or more register outlets.

11. The method of claim 10, including configuring the one or more ducts to direct ambient air from the motor vehicle ambient air inlet, through one or more air inlet air filters, and then directly to the vehicle duct system supplying air to the passenger cabin via the one or more register outlets.

12. The method of claim 10, including configuring the one or more ducts to direct ambient air from the motor vehicle ambient air inlet, through a plenum, and then directly to the vehicle duct system supplying air to the passenger cabin via the one or more register outlets.

13. The method of claim 10, including configuring the one or more ducts to direct ambient air from the motor vehicle ambient air inlet, through one or more air inlet air filters, through a plenum, and then directly to the vehicle duct system supplying air to the passenger cabin via the one or more register outlets.

14. A motor vehicle air distribution system, comprising:
a heating, ventilation, and air-conditioning (HVAC) unit comprising at least a compressor, an evaporator, and a forced-air blower;
a primary air distribution system supplying air to an interior of a passenger compartment of the vehicle, including one or more air ducts placing the ambient air inlet in fluid communication with the HVAC unit, a plenum, and one or more dash panel register outlets; and
a supplemental air distribution system supplying air to an interior of a passenger compartment of the vehicle, including one or more supplemental ducts placing the ambient air inlet in fluid communication with at least the one or more dash panel register outlets, wherein the one or more supplemental ducts bypass at least the HVAC unit evaporator and forced-air blower.

15. The air distribution system of claim 14, wherein the one or more supplemental ducts each include an actuable door for allowing and preventing an airflow therethrough.

16. The air distribution system of claim 15, wherein the one or more supplemental ducts are configured to place the ambient air inlet in fluid communication with a vehicle dash panel duct arrangement and the one or more dash panel register outlets.

17. The air distribution system of claim 15, wherein the one or more supplemental ducts are configured to place the ambient air inlet in fluid communication with one or more air inlet air filters, the vehicle dash panel duct arrangement, and the one or more dash panel register outlets.

18. The air distribution system of claim 15, wherein the one or more supplemental ducts are configured to place the ambient air inlet in fluid communication with the plenum, the vehicle dash panel duct arrangement, and the one or more dash panel register outlets.

19. The air distribution system of claim 17, wherein the one or more supplemental ducts are configured to place the ambient air inlet in fluid communication with the one or more air inlet air filters, the plenum, the vehicle dash panel duct arrangement, and the one or more dash panel register outlets.

20. A motor vehicle including the air distribution system of claim 14.
